(19) United States
(12) Patent Application Publication
(10) Pub. No.: US 2009/0150912 A1
(43) Pub. Date: Jun. 11, 2009

(54) Optical Disk Device with Magnetic Latching Function and the Same in Computer Apparatus

(75) Inventor: Cheng-Yuan Yang, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ASUSTeK Computer Inc., Taipei (TW)

(21) Appl. No.: 12/274,802

(22) Filed: Nov. 20, 2008

(30) Foreign Application Priority Data
Dec. 6, 2007 (TW) 96146605

(51) Int. Cl. G11B 17/04

(52) U.S. Cl. 720/610; G9B/17.013

(57) ABSTRACT

The present invention relates to a computer apparatus and its optical disk device with magnetic latching function. The optical disk device includes a main body and a disk tray moveably provided in the main body to be released or returned into the main body. The disk tray has a magnetic member on one side thereof and corresponds to a variable magnetic member in the main body while the disk tray is returned into the main body. The variable magnetic member is controlled to have the same or the opposite magnetism as the magnetic member has, for attracting the magnetic member to forcedly latch the disk tray in the main body, or for not attracting the magnetic member to free the disk tray.

### RELATED APPLICATIONS

This application claims priority to Taiwan Application Serial Number 96146605, filed Dec. 6, 2007, which is herein incorporated by reference.

### BACKGROUND

1. Field of Invention

The present invention relates to an optical disk device, more particularly to an optical disk device with magnetic latching function.

2. Description of Related Art

An optical disk device is often provided at one side of a notebook computer. When a disk tray elastically provided in the optical disk device for carrying a disk is pushed back inside the optical disk device, the disk tray is latched by a mechanical tenon of the optical disk device. Thus the disk tray is not easy to be released elastically from the optical disk device. When the disk tray is desired to be released from the optical disk device by a user, a release button provided at a front panel of the optical disk device can be pressed by the user and the disk tray is outwardly conveyed with a mechanical fashion.

Although the disk tray is latched in the optical disk device by the mechanical tenon so as to dispose in the optical disk device, the mentioned mechanical tenon latches the disk tray with a certain force-applying direction. Whenever the notebook computer is fallen to the ground or the optical disk device is struck by an external force, the mechanical tenon may be shocked by the generated vibration. The disk tray is therefore unintentionally released and the disk tray may be damaged or the optical disk disposed on the disk tray is more likely to fall. Such disadvantage may bring inconvenience for a user and shall be improved.

### SUMMARY

The present invention relates to an optical disk device with magnetic latching function and the same in a computer apparatus. Wherein the optical disk device with magnetic latching function includes a main body and a disk tray, the disk tray is moveably provided in the main body and can be released or returned into the main body. The main body has a variable magnetic member provided therein. When the variable magnetic member is controlled to have the magnetism different from the magnetism that the magnetic member has, the variable magnetic member is served to attract the magnetic member, so the disk tray is forcedly latched in the main body. On the other hand, when the variable magnetic member is controlled to have the same magnetism as the magnetism that the magnetic member has, the magnetic member is no longer attracted, so the disk tray is no longer forcedly latched in the main body, and the disk tray can be released by the main body with a conventional fashion.

The present invention also provides a computer apparatus having the optical disk device, that includes a computer mainframe, an optical disk device and a variable magnetic member. A space is provided in the computer mainframe for receiving the optical disk device. The optical disk device includes a main body, a disk tray and a magnetic member. The disk tray can be released or returned to the main body, the magnetic member is provided at one side of the disk tray, and the variable magnetic member is provided in the space of the computer mainframe. The variable magnetic member is corresponding to the magnetic member when the disk tray is received in the main body.

When information that the disk tray is returned and received by the main body is provided to the computer mainframe, the variable magnetic member is controlled by the computer mainframe to have the magnetism different from the magnetism that the magnetic member has. Then, the variable magnetic member is served to attract the magnetic member, the disk tray is therefore forcedly latched in the main body. However, when a release button provided at a front panel of the main body is pressed, the main body provides the information that the release button being pressed to the computer mainframe. The computer mainframe can change the current magnetism of the variable magnetic member to the same magnetism as the magnetism that the magnetic member has, so the disk tray is no longer forcedly latched in the main body and the disk tray can be released by the main body with a conventional fashion.

The present invention utilizes the magnetism changeable property of the variable magnetic member and the effect of magnetic attracting and repulsing between the variable magnetic member and the magnetic member, the object of latching the disk tray is therefore achieved.

### BRIEF DESCRIPTION OF THE DRAWINGS

The structure and the technical means adopted by the present invention to achieve the above and other objectives can be best understood by referring to the following detailed description of the preferred embodiments and the accompanying drawings, where:

FIG. 1 is a structural schematic view of an external optical disk device of the first embodiment of the present invention; and

FIG. 2 is a structural schematic view of a notebook computer having the optical disk device of the second embodiment of the present invention.

### DESCRIPTION OF THE PREFERRED EMBODIMENTS

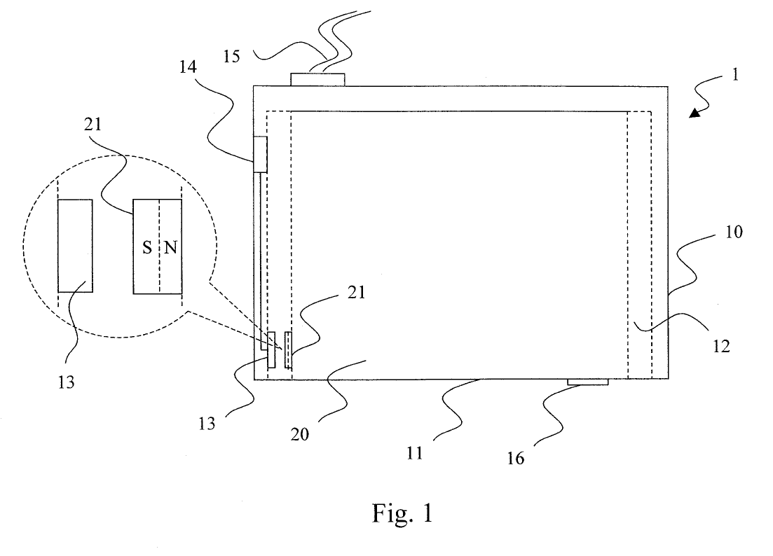

The optical disk device provided by the present invention can be a CD-ROM, CD-R, CD-R/W, DVD, MO or external optical disk device etc. Refer to FIG. 1, which is a structural schematic view of an external optical disk device of the first embodiment of the present invention. The optical disk device 1 includes a main body 10 and a disk tray 20, wherein the structure of the main body 1 is a conventional optical disk structure that includes all electronic units, e.g. a laser source, an optical reading/writing device, etc. and all mechanical units, e.g. an inserting/releasing mechanism for the disk tray 20, tenons for latching the disk tray 20, and resilient sheets served to release the disk tray 20.

One side of the main body 10 has an opening 11 and an accommodating space 12 that communicates with the opening 11, so the disk tray 20 can be moveably released out of the main body 10 via the opening 11 or be received in the accommodating space 12 of the main body 10 by the inserting/releasing mechanism for the disk tray 20. The above mentioned electronic and mechanical units of the optical disk device 1 are commonly-known arts and are compatible with the present invention, thus no further description regarding to the electronic and mechanical units will be illustrated hereinafter.

The difference between the present invention and the above described art is that a magnetic member 21 is provided on one side of the present invention of the disk tray 20 and can be a permanent magnet, as known as a magnetite, having south/north magnetic poles.

When the disk tray 20 is returned and received in the accommodating space 12 of the main body 10, a variable magnetic member 13, e.g. an electromagnet, is provided on the main body 10 corresponding to the magnetic member 21. The main body 10 further includes a control chip 14. The control chip 14 is electrically connected to the variable magnetic member 13 for determining a direction of current flows via the variable magnetic member 13. Thus, when the direction in which the current flows via the variable magnetic member 13 is changed, the magnetism of the variable magnetic member 13 is changed to be N pole or S pole.

For the purpose of clear illustration, the magnetic member 21 is divided into two surface, and a first magnetic pole, e.g. north pole, is defined on one of the surfaces closer to the disk tray 20, and a second magnetic pole, e.g. south pole is defined on another one of the surfaces closer to the variable magnetic member 13. The magnetism of the first magnetic pole is always opposite to the magnetism of the second magnetic pole.

In the first embodiment of the present invention, the main body 10 is an external optical disk device, a connecting unit 15, e.g. a USB connecting unit, or a bus connecting unit, of the main body 10 is electrically connected to a computer mainframe. When a release button 16 provided at the front panel of the main body 10 is touched and actuated, the direction in which the current flows via the variable magnetic member 13 is first changed by the control chip 14. Then, the magnetism, e.g. N pole, of the variable magnetic member 13 is changed to the same magnetism as the magnetism of the second magnetic pole, e.g. S pole. Therefore, a magnetic repulsing effect is generated between the variable magnetic member 13 and the magnetic member 21 so the magnetic number 21 is not be attracted, the disk tray 20 is thus no longer forcedly latched in the main body 10. Then the disk tray 20 is released out of the main body 10 via the opening 11 by the inserting/releasing mechanism for the disk tray 20.

In contrast, when the disk tray 20 is desired to return into the main body 10, the disk tray 20 is firstly received in the accommodating space 12 of the main body 10 via the opening 11 by the inserting/releasing mechanism for the disk tray 20. After the disk tray 20 is positioned and latched, the direction in which the current flows via the variable magnetic member 13 is changed again by the control chip 14. Then, the current magnetism, e.g. S pole, of the variable magnetic member 13 is changed to differ from the magnetism of the second magnetic pole e.g. N pole. Thus a magnetic attracting effect is generated between the variable magnetic member 13 and the magnetic member 21, so the disk tray 20 is forcedly latched in the main body 10. A problem of unintentionally releasing the disk tray 20 due to an external forced applied on the optical disk device 1 is solved and assistance to enhance the latching ability of the tenon serving for latching the disk tray 20 is also provided.

What shall to be noteworthy is that the direction in which the current flows via the variable magnetic member 13 is not necessary to be changed by the main body 10 in order to achieve an object of not attracting the magnetic member 12 when the disk tray 20 is desired to be released by the main body 10. In other words, the current flows via the variable magnetic member 13 can be directly cut off by the main body 10. Once the variable magnetic member 13 has lost its magnetism, the disk tray 20 disposed in the main body 10 is also not attracted by the variable magnetic member 13.

In the first embodiment of the external optical disk device illustrated above, the variable magnetic member 13 is provided in the main body 10 of the optical disk device, and is controlled by the control chip 14 of the main body 10 in order to perform on latching or releasing the magnetic member 21.

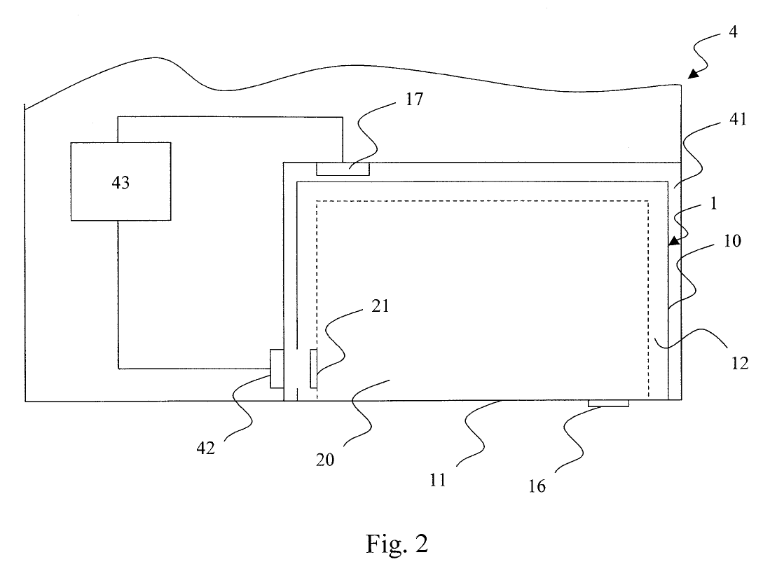

A second embodiment provided by the present invention is as shown in FIG. 2, which is a structural schematic view of a notebook computer having the optical disk device. The optical disk device 1 provided by the present invention is disposed in a space 41 of a computer mainframe 4, especially a notebook computer, and a connecting unit 17 of the optical disk device 1 is electrically connected to a control circuit 43, the control circuit 43 is a circuit mainly including an active unit, e.g. MCU.

The difference between the second embodiment and the first embodiment is that a variable magnetic member 42 is provided in the computer mainframe 4 and is facing the location where the space 41 is provided. When the disk tray 20 is received in the main body 10, the variable magnetic member 42 is corresponding to the magnetic member 21. In detailed description, the variable magnetic member 42 can be disposed on a top side or a bottom side of the housing of the computer mainframe 4, or on the control circuit 43 that faces to the magnetic member 21 through the main body 10. Wherein the variable magnetic member 42 is electrically connected to the control circuit 43, so the variable magnetic member 42 can receive signals outputted from the control circuit 43.

When the release button 16 of the front panel of the main body 10 is touched and actuated, the main body 10 outputs a releasing signal via the connecting unit 17 to the control circuit 43. Then the direction in which the current flows via the variable magnetic member 42 is changed by the control circuit 43, so the original magnetism, e.g. N pole, of the variable magnetic member 42 is changed to the same magnetism as the magnetism of the second magnetic pole e.g. S pole. Therefore, a magnetic repulsing effect is generated between the variable magnetic member 42 and the magnetic member 21, so the magnetic member 21 is not attracted, and the disk tray 20 is no longer forcedly latched in the main body 10.

When the disk tray 20 is desired to be returned and received in the main body 10, the disk tray 20 is firstly received in the accommodating space 12 via the opening 11 by the main body 10. Then an inserting signal is outputted by the main body 10 via the connecting unit 17 to the control circuit 43. The direction in which the current flows via the variable magnetic member 42 is again changed by the control circuit 43, so the current magnetism, e.g. S pole, of the variable magnetic member 42 is changed to the magnetism, e.g. N pole, different from the magnetism of the second magnetic pole , e.g. S pole. Therefore a magnetic attracting effect is generated between the variable magnetic member 42 and the magnetic member 21, and the disk tray 20 is forcedly latched in the main body 10.

As the same art disclosed at the first embodiment of the present invention, the current flows via the variable magnetic member 42 can be directly cut off by the control circuit 43, so the disk tray 20 disposed in the main body 10 is free from the attraction of the variable magnetic member 42.

The release button 16 served to release the disk tray 20 can be served to actuate a status in which the variable magnetic member 42 and the second magnetic pole are not attracted to each other. Thus, an additional button for stopping magnetic attraction is not needed on the optical disk device 1, so the structure of the optical disk device 1 is remained in order to provide a simple opening/closing operation to users.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A computer apparatus having optical disk device with magnetic latching function, comprising:
a computer mainframe having a space;
an optical disk device, comprising:
a main body provided in the space;
a disk tray moveably provided in the main body to be released or returned to the main body; and
a magnetic member provided on one side of the disk tray; and
a variable magnetic member provided in the computer mainframe facing the space,
wherein while the disk tray is returned to the main body, it faces the magnetic member; the variable magnetic member is controlled whether to attract the magnetic member or not by the computer mainframe.

2. The computer apparatus as claimed in claim 1, wherein the computer mainframe further includes a control circuit, the control circuit is electrically connected to the main body and the variable magnetic member for determining a direction of current flows via the variable magnetic member.

3. The computer apparatus as claimed in claim 2, wherein while the disk tray is returned and received in the main body, the direction in which the current flows via the variable magnetic member is changed by the control circuit to differ the magnetism of the variable magnetic member from the magnetism of the magnetic member so as to attract the magnetic member and latch the disk tray.

4. The computer apparatus as claimed in claim 2, wherein before the disk tray is released by the main body, the direction in which the current flows via the variable magnetic member is changed by the control circuit to make the magnetism of the variable magnetic member as same as the magnetism of the magnetic member so as not to attract the magnetic member and release the disk tray.

5. The computer apparatus as claimed in claim 2, wherein before the disk tray is released by the main body, the current flows via the variable magnetic member are cut off by the control circuit so as not to attract the magnetic member and release the disk tray.

6. An optical disk device with magnetic latching function, comprising:
a main body;
a disk tray moveably provided in the main body to be released or returned to the main body;
a magnetic member provided on one side of the disk tray; and
a variable magnetic member provided in the main body, while the disk tray is returned to the main body, it faces the magnetic member; the variable magnetic member is controlled whether to attract the magnetic member or not.

7. The optical disk device as claimed in claim 6, wherein the main body further includes a control chip, the control chip is electrically connected to the variable magnetic member for determining a direction of current flows via the variable magnetic member.

8. The optical disk device as claimed in claim 7, wherein while the disk tray is returned and received in the main body, the direction in which the current flows via the variable magnetic member is changed by the control chip to differ the magnetism of the variable magnetic member from the magnetism of the magnetic member so as to attract the magnetic member and latch the disk tray.

9. The optical disk device as claimed in claim 7, wherein before the disk tray is released by the main body, the direction in which the current flows via the variable magnetic member is changed by the control chip to make the magnetism of the variable magnetic member as same as the magnetism of the magnetic member so as not to attract the magnetic member and release the disk tray.

10. The optical disk device as claimed in claim 7, wherein before the disk tray is released by the main body, the current flows via the variable magnetic member are cut off by the control chip and then the variable magnetic member has not magnetism so as to release the disk tray.
